(19) United States
(12) Patent Application Publication
(10) Pub. No.: US 2026/0359901 A1
(43) Pub. Date: Nov. 12, 2026

(54) PLANT CARE METHOD AND SYSTEM, AND READABLE STORAGE MEDIUM

(71) Applicant: Hangzhou Ruisheng Software Co., Ltd., Zhejiang (CN)

(72) Inventors: Huan Luo, Zhejiang (CN); Mingquan Chen, Zhejiang (CN); Tao He, Zhejiang (CN)

(73) Assignee: Hangzhou Ruisheng Software Co., Ltd., Zhejiang (CN)

(21) Appl. No.: 19/135,086

(22) PCT Filed: Nov. 30, 2023
(86) PCT No.: PCT/CN2023/135271

§ 371 Date: Jun. 3, 2025

(30) Foreign Application Priority Data
Dec. 7, 2022 (CN) 202211564831.2

(51) Int. Cl. G06Q 50/02; G06Q 10/0631

(52) U.S. Cl. CPC G06Q 50/02; G06Q 10/063114

(57) ABSTRACT

A plant care method and system, and a readable storage medium. The method includes the following steps: receiving a plant added by a user, and acquiring attribute information of the plant; determining an initial care plan for the plant according to the attribute information of the plant, wherein the initial care plan includes a plurality of initial care tasks and the time at which each initial care task should be executed; acquiring information of a co-carer of the plant, and respectively pushing the plant and an actual care task to the co-carer according to the time at which each initial care task should be executed; and after it is confirmed that the actual care task has been completed, synchronizing care progress information of the plant to the co-carer.

### TECHNICAL FIELD

The disclosure relates to the field of computer technology, and more particularly, to a plant care method and system, and a readable storage medium.

### DESCRIPTION OF RELATED ART

Current plant care plans are designed based on plant categories. That is, plant species are first recognized, and then the care plans are determined based on the species. In order to obtain a care plan that is more suitable for plants, some plans further consider factors such as a planting environment, current growth stage, and current seasonal weather of the plant when formulating the care plans. However, the current care plans do not take into account a situation where multiple users collectively care the plants. Since care habits and care capabilities of different users vary significantly, how to generate a care plan for the plants that is suitable for the users to collectively perform has become an urgent issue to be solved in the art.

### SUMMARY

One of the objectives of the disclosure is to provide a plant care method, including:
A plant added by a user is received, and attribute information of the plant is acquired;
An initial care plan for the plant is determined according to the attribute information of the plant, and the initial care plan includes multiple initial care tasks and time at which each initial care task should be executed;
Information of a co-carer of the plant is acquired, and the plant and an actual care task are respectively pushed to the co-carer according to the time at which each initial care task should be executed;
After it is confirmed that the actual care task has been completed, care progress information of the plant is synchronized to the co-carer.

In some embodiments, the actual care task is adjusted and then pushed according to the initial care tasks of the care plan and different care ability levels of the co-carer.

In some embodiments, the different care ability levels of the co-carer are acquired through care history data of the user or in an interactive manner.

In some embodiments, the co-carers are able to interact with each other to determine the actual care task and a processing method thereof.

In some embodiments, determining the initial care plan for the plant according to the attribute information of the plant includes:

The initial care plan for the plant is determined according to category information of the plant, a care position of the plant, and the current time.

In some embodiments, the co-carer includes an original carer, a newly added carer, and/or a temporary carer.

In some embodiments, a method of adding the co-carer includes the following methods:
The co-carer is determined by associating a family account;
And/or the original carer pushes a message to the newly added carer and/or the temporary carer to confirm an invitation;
And/or the newly added carer and/or the temporary carer actively add the same plant with same care position information, and send collective care information to the original carer to be confirmed by the original carer.

In some embodiments, the newly added carer and/or the temporary carer include a friend whose care ability level meets current plant care requirements or who has relevant plant care experience or other users near the care position, and are selected by the original carer to send an invitation confirmation.

In some embodiments, the newly added carer and/or the temporary carer are able to invite a third carer to join collective care.

In some embodiments, when the plant and the actual care task are respectively pushed to the co-carer, the method further includes pushing historical care record of the plant to the co-carer.

In some embodiments, the method further includes distinguishing and setting push information of the actual care task according to a care position of the plant and position information of each co-carer, giving strong prompts to the co-carer within a preset distance, and only giving weak prompts to the co-carer outside the preset distance.

In some embodiments, after it is confirmed that the actual care task has been completed, synchronizing the care progress information of the plant to the co-carer includes: the co-carer who completes the actual care task is able to upload specific information of the executed actual care task, and synchronize a latest care task state to other co-carers.

According to another aspect of the disclosure, a plant care system is provided, including a processor and a memory. A program is stored in the memory, and when the program is executed by the processor, the above plant care method is implemented.

According to another aspect of the disclosure, a readable storage medium is provided, having a program stored thereon. When the program is executed, the above plant care method is implemented.

Other features and advantages of the disclosure will become more apparent from the following detailed description of exemplary embodiments of the disclosure with reference to the accompanying drawings.

### BRIEF DESCRIPTION OF THE DRAWINGS

The accompanying drawings, which constitute a part of the specification, illustrate the embodiments of the disclosure and, together with the specification, serve to explain the principles of the disclosure.

FIG. 1 is a schematic flow chart of a plant care method provided according to an embodiment of the disclosure.

FIG. 2 is a schematic view of a structure of a plant care system according to an embodiment of the disclosure.

Note that in the embodiments described below, the same reference numerals may be used in common among different drawings to indicate the same parts or parts having the same functions, and repeated descriptions thereof may be omitted. In some cases, similar reference numerals and letters are used to denote similar items, and thus, once an item is defined in one accompanying drawing, further discussion thereof is not necessary in subsequent accompanying drawings.

For ease of understanding, a position, size, range, etc. of each structure shown in the drawings and the like may not represent the actual position, size, range, etc. Therefore, the disclosure is not limited to the position, size, range, etc. disclosed in the drawings and the like.

### DETAILED DESCRIPTION OF DISCLOSED EMBODIMENTS

Various exemplary embodiments of the disclosure will be described in detail below with reference to the accompanying drawings. It should be noted that the relative arrangement of components and steps, the numerical expressions and values set forth in these embodiments do not limit the scope of the disclosure unless specifically stated otherwise.

The following description of at least one exemplary embodiment is merely illustrative in nature and is in no way intended to limit the disclosure, and applications or uses thereof. That is, structures and methods herein are shown in an exemplary manner to describe different embodiments of the structures and methods in the disclosure. However, those skilled in the art will appreciate that they are merely illustrative of exemplary ways in which the disclosure may be implemented, and not exhaustive. Furthermore, the accompanying drawings are not necessarily drawn to scale, and some features may be enlarged to show details of specific components.

Technologies, methods, and devices known to those skilled in the relevant art may not be discussed in detail, but where appropriate, the technologies, methods, and devices should be considered a part of the authorization specification.

In all examples shown and discussed herein, any specific values should be interpreted as merely exemplary and not as limiting. Therefore, other examples of the exemplary embodiments may have different values.

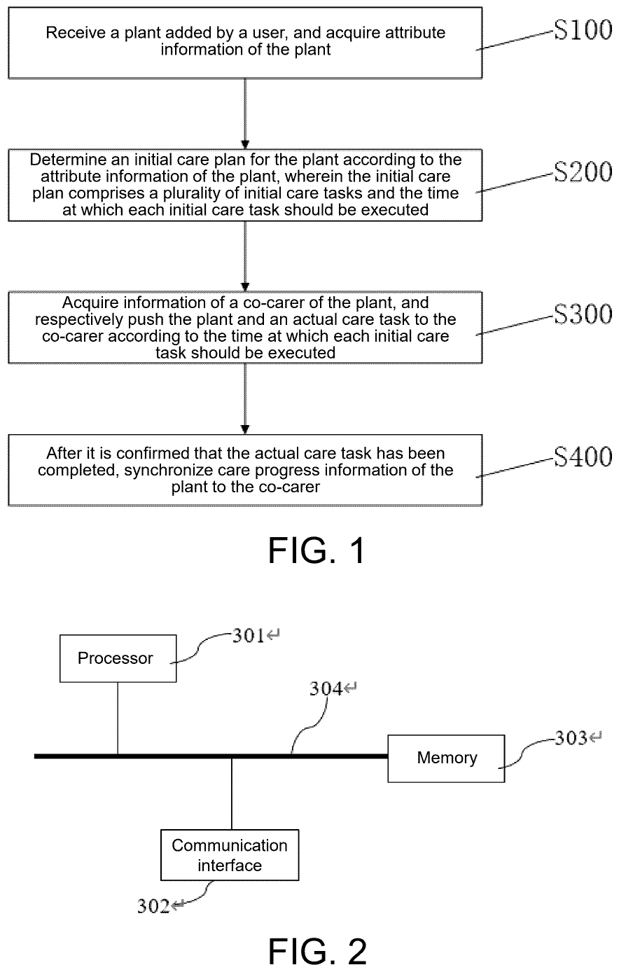

FIG. 1 is a schematic flow chart of a plant care method provided according to an embodiment of the disclosure. The method may be implemented in an application program (app) installed on an intelligent terminal such as a mobile phone, a tablet computer, or a wearable device. As shown in FIG. 1, the method includes:
In step S100, a plant added by a user is received, and attribute information of the plant is acquired;
In step S200, an initial care plan for the plant is determined according to the attribute information of the plant, and the initial care plan includes multiple initial care tasks and time at which each initial care task should be executed;
In step S300, information of a co-carer of the plant is acquired, and the plant and an actual care task are respectively pushed to the co-carer according to the time at which each initial care task should be executed;
In step S400, after it is confirmed that the actual care task has been completed, care progress information of the plant is synchronized to the co-carer.

A plant image provided by the user may be acquired through a camera of the intelligent terminal such as the mobile phone, the tablet computer, the wearable device, etc., or may be acquired by manually adding and uploading by the user.

A species recognition model may be a neural network model, specifically a convolutional neural network model or a residual network model. The convolutional neural network model is a deep feedforward neural network, which uses convolution kernels to scan a species image, extract multiple features to be recognized in the species image, and then recognize the features to be recognized of a species. In addition, in a process of recognizing the species image, an original species image may be directly input into the convolutional neural network model without preprocessing the species image. Compared to other recognition models, the convolutional neural network model has higher recognition accuracy and recognition efficiency.

Compared to the convolutional neural network model, the residual network model has an additional identity mapping layer, which may avoid a phenomenon of accuracy saturation or even decrease caused by an increase of network depth (the number of stacked layers in a network). An identity mapping function of the identity mapping layer in the residual network model is required to satisfy: a sum of the identity mapping function and an input of the residual network model is equal to an output of the residual network model. After introduction of identity mapping, changes in the output of the residual network model are more obvious, thus greatly improving recognition accuracy and recognition efficiency of the features of the species.

In some embodiments, training a feature classification model may include:
A first sample set having the preset number of species images annotated with multiple feature information is acquired;
A certain proportion of the species images is determined from the first sample set as a first training set;
The feature classification model is trained using the first training set; and
When first training accuracy is greater than or equal to first preset accuracy, the training is ended, and a trained feature classification model is acquired.

Specifically, the first sample set may include a large number of species images, and each species image is correspondingly annotated with the corresponding features thereof. The species images are input into the feature classification model to generate output feature information, and then relevant parameters in the feature classification model may be adjusted according to a comparison result between the output feature information and the annotated feature information. That is, the feature classification model is trained until the training is ended when the first training accuracy of the feature classification model is greater than or equal to the first preset accuracy, thereby acquiring the trained feature classification model. According to one species image, the feature classification model may also output multiple candidate features, and each candidate feature may have corresponding feature confidence thereof for further analysis and screening.

Furthermore, the feature classification model acquired from the training may be tested, which may include:
A certain proportion of the species images is determined from the first sample set as a first test set;
First model accuracy of the trained feature classification model is determined using the first test set; and
When the first model accuracy is less than second preset accuracy, the first training set and/or the feature classification model are adjusted for retraining.

Generally speaking, the species images in the first test set and the first training set are not exactly the same, so the first test set may be used to test whether the feature classification model has a good recognition effect on species images outside the first training set. During the test, the first model accuracy of the feature classification model is calculated by comparing the output feature information generated according to the species images in the first test set to the annotated feature information. In some examples, a calculation method of the first model accuracy may be the same as a calculation method of the first training accuracy. When the first model accuracy acquired from the test is less than the second preset accuracy, it indicates that the recognition effect of the feature classification model is not good enough. Therefore, the first training set may be adjusted. Specifically, for example, the number of species images annotated with the feature information in the first training set may be increased, or the feature classification model itself may be adjusted, or both of the above may be adjusted, and then the feature classification model may be retrained to improve the recognition effect thereof. In some embodiments, the second preset accuracy may be set to be equal to the first preset accuracy.

In addition, in a recognition result page of the plant that has been recognized in a user history, or a plant care interface manually added by the user, a subsequent collective care process of the plant may be also directly entered, thus skipping the processing of recognition of the plant species again. The user may also add the plant that is required to be cared collectively by searching for the plant, for example, by searching for a plant name to acquire the attribute information of the plant.

Acquiring the attribute information of the plant includes acquiring species category information of the plant and care position information of the plant. In addition, it may further include plant attribute information such as historical care record information of the plant, health information of the plant, and disease and pest information. The above plant attribute information is used for a subsequent collective care processing process of the plant. Furthermore, the attribute information of the plant may further include growth stage information thereof, and the growth stage may include one of a seed/seedling stage, a growing stage, a flowering stage, a fruiting stage, a dormant stage, and a drying stage. The growth stage of the plant may be recognized based on a neural network model established in advance through sample training, which may be a separate recognition model, or the same model fused with the species recognition model. Acquiring the growth stage information of the plant may more accurately set an initial plant care plan in accordance with actual conditions.

Furthermore, acquiring the attribute information of the plant further includes acquiring care environment information of the plant to adjust the initial care plan, thereby determining the actual care task of the plant. The care environment information may include weather, temperature, humidity, soil moisture, light intensity, different care locations such as indoor or outdoor. The care environment information may be acquired in different ways. For example, environmental information such as weather, temperature, and humidity may be automatically acquired through the Internet, the light intensity may be acquired according to a device with a photometer function, and the care location information may be recognized and acquired according to a pre-trained neural network model. The above care environment information may be further provided by the user through interactive questions. At the same time, when it is recognized (or the user actively provides information) that care environment conditions have changed, the actual care task of the plant may be further adjusted in time.

In some embodiments, determining the initial care plan for the plant according to the attribute information of the plant includes: determining the initial care plan for the plant according to the category information of the plant, the care location of the plant, and the current time. After species attribute information such as species name information and the growth stage information of the plant of the user is acquired, care information may be acquired from a plant care information database associated with the plant, and then combined with position information of the user and current time information to obtain position information and season information of the plant, thereby determining the initial care plan for the plant.

The position information of the user may be determined by position information when uploading the plant image, and the position information includes but is not limited to GPS information. Specifically, when the user uploads the plant image, the current position information of the user is acquired. If the current position information of the user is displayed as “The Bund, Shanghai”, it may be determined that geographical information of a location of the user is Shanghai, China. If the current position information of the user is displayed as “Columbia University, New York”, it may be determined that the geographical information of the location of the user is New York, USA. The position information of the user may be divided into hierarchical attributes of multiple regions from small to large ranges. For example, if the current position information of the user is Binjiang District, Hangzhou City, Zhejiang Province, China, then multiple hierarchical attributes thereof may be regions such as Binjiang District, Hangzhou City, Zhejiang Province, China, East Asia, Asia sequentially.

The position information of the user and the current time information are not necessary information. However, acquiring the position information of the user may determine the position information of the plant, and the current time information may determine the season information. Different positions and different seasons have different climate characteristics, and different climate characteristics may have different care plans or key points to note. For example, more watering is required in a hot tropical dry season, so the care plan for the corresponding plant may be initially adjusted to determine the initial care plan for the plant.

In some embodiments, the actual care task is adjusted and then pushed according to the initial care tasks of the care plan and different care ability levels of the co-carer. The care ability levels of different co-carers are not the same. Some users may have a beginner level, while some users have reached an expert level of care ability. Therefore, the initial care task is required to be adjusted and then pushed according to the care ability levels of different users, so as to be suitable for the care ability levels of different co-carers.

The different care ability levels of the co-carers are respectively obtained through care history data of the user or in an interactive manner. Care ability level information of the user and a degree of understanding of the plant may be acquired by recognizing historical plant care records of the user, such as acquiring type information of the plant that the user has cared in the past (when the care types include plants that are more difficult to care, it may be considered that the user has a high care ability level), and acquiring care data of the user, such as a frequency and time of care (when the care frequency is higher, and the time is longer, it may be considered that the user has a high care ability level). The care level information of the user may be further determined by recognizing and acquiring a health state and a plant state of the plant state by the user. The health state of the plant state by the user may be recognized through a plant disease and pest recognition model established through corresponding pre-sample training, thereby acquiring whether the plant cared by the user have health conditions such as diseases and pests, and severity of the diseases and pests. The plant state cared by the user may be recognized and confirmed through a plant state recognition model established through corresponding pre-sample training. The plant state may be divided into multiple levels from high to low according to a degree of goodness, for example, excellent, good, average, and poor. A growth state may be further scored and divided into multiple levels according to score ranges. According to the health state and the plant state of the plant cared by the user, various data may be combined to determine user level information of the user. For example, the care ability levels of the user may be divided into multiple different levels (such as poor, elementary, intermediate, advanced, expert, etc.). Different actual care tasks may be set for the users with different levels of user care ability levels, or more different levels may be divided according to the actual care ability level information of the current co-caring users. Furthermore, corresponding plan adjustments may be made for each situation, so as to push the actual care task suitable for each co-caring user.

The care ability level information may be further confirmed according to interactive question answer information and/or customized care ability label information submitted by the current user. The care ability level information of the user may be determined by providing interactive questions, such as asking the user to select answers to multiple questions through a questionnaire to obtain corresponding data, thereby comprehensively determining the care ability level of the user. In addition, the users may further evaluate their own care ability levels to customize level labels of the care ability levels. For example, the users may click to select their own assessed care ability level from the level labels of the care ability levels, including: poor, elementary, intermediate, advanced, expert, etc. In addition, care operation labels may be added for the corresponding user according to specific operation records in historical care data of the user. For example, if one user has performed a pot-changing operation in the historical care records, the user may be labeled with a care operation label indicating that the user has an ability to change pots, and the label may be retained in the care plan with the pot-changing operation. For the users who do not have the ability to change pots, the pot-changing operation may be deleted from the corresponding care plan.

Care operations may include, for example, at least one of watering, spraying, changing water, adding water, fertilizing, changing soil, pruning, weeding, transplanting, repotting, sun exposure, sun shading, adjusting temperatures, adjusting humidity, winter protection, applying pesticides, and applying fungicides. Each operation may further have subdivided subcategories. For example, fertilization may include subcategories such as applying slow-release fertilizer, water-soluble fertilizer, liquid fertilizer. Execution frequencies of different subcategories may be different. The care operations are subdivided into the subcategories, which may more accurately push the appropriate actual care task to co-carers with different care ability levels. The suggested subcategory of the care operation may be determined according to the plant species and the growth stage, and may also be determined according to preferences input by the user.

After acquiring the care ability level information of different co-caring users, it is used to adjust the initial care task. That is, the care operations that do not meet the care ability level of the current co-caring user are deleted from the plan, or the corresponding care operations are reduced, so as to determine the actual care task of the current co-caring user to be pushed.

Scenarios of the co-caring plant may be divided into local co-caring and remote co-caring. The local co-caring mainly involves: family members, roommates, classmates, or colleagues collectively caring the plant in their residence or public areas; the remote co-caring mainly includes: when the original carer is on a business trip or away from home, the carer temporarily hands over the plant to others for care, or other users give a plant to another person, but the user may remotely care the plant with the actual carer or pay attention to a caring situation of the plant, or when the care ability is insufficient, the carer may find someone with a high care level in a different location to collectively care the plant, and guidance or reminders may be provided through text, pictures, voice, or videos.

In some embodiments, the co-carers may interact with each other to determine the actual care task and a processing method thereof. The care ability levels of different co-carers may be inconsistent, and the actual carer may need some caring guidance. The co-carer with the higher care ability level may provide the guidance or reminders through text, voice, or videos. The actual carer may also provide details of his or her actual care task, including recording a caring process through text, pictures, or videos. The actual carer may further upload photos of the plant before and after caring for the co-carer to view. The co-carer may also score performance of the actual care task of the actual caring user. A system may also score states of the plant before and after caring, and then update the care ability level information of the actual caring user according to a scoring difference between the states of the plant before and after caring and/or scoring results of the performance of the actual care task of the actual caring user.

In some embodiments, the co-carer includes the original carer, a newly added carer, and/or a temporary carer. The original carer includes an owner of the plant or the user who adds the plant for care for the first time. The new carer and the temporary carer are other co-carers other than the original carer. The temporary carer can be set as a carer for a certain period of time and will automatically become invalid after the expiration, which is convenient for managing the co-carers. The new carer and the temporary carer may be one or more, with no limit on the number.

A method for adding the co-carer includes the following:
The co-carer is determined by associating a family account, multiple sub-accounts under the same family account may be associated and displayed, and the original co-carer may select one or more associated users to determine the co-carer;
The original carer pushes a message to the newly added carer and/or the temporary carer to confirm an invitation, the original carer may actively select other users to invite them to join the collective care, other users may join in the collective care of the plant after confirming through the push message;
The newly added carer and/or the temporary carer actively add the same plant with the same care position information and send collective care information to the original carer to be confirmed by the original carer. Plants with the same care position information and the same species information may be considered to be the same plant. If the plants to be cared together belong to a situation where there are multiple identical plants in the same position, it may also be considered that these identical plants are required to be included in the collective care. When other users apply to join the collective care of the plant, the original carer may confirm and approve the users he agrees to join as the newly added carer or the temporary carer.

In some embodiments, the newly added carer and/or the temporary carer include a friend whose care ability level meets the current plant care requirements or who has relevant plant care experience or other users near the care position, and are selected by the original carer to send an invitation confirmation. The system may determine whether the original carer meets the requirements for caring the current plant according to the care ability level thereof. If not, the system may automatically list the users among his or her friends who have the corresponding carer ability level, and then list the users for the original carer to choose and request for the collective care. If none of his or her friends have the users with the corresponding care ability level, the original carer may select corresponding users from other nearby users displayed or recommended by the system to join the collective care.

In some embodiments, the newly added carer and/or the temporary carer may invite a third carer to join the collective care. The newly added carer and the temporary carer may feel that they also need certain guidance and help, or they feel the need to share the care of the plant for third parties to learn or study. Therefore, the newly added carer and the temporary carer may invite one or more third carers to join the collective care again. An invitation request may be set to require the consent of the original carer before joining the collective care.

In some embodiments, respectively pushing the plant and the actual care task to the co-carer further includes pushing the historical care records of the plant to the co-carer. The historical care records of the plant may help the actual carer among the co-carers to determine how to perform caring according to the actual care task. Different care ability levels of the co-carers will also lead to different actual care tasks, which may appear in the historical care records of the plant. For example, different operation records of fertilization will cause the current actual carer to make different choices, thereby handling different actual care tasks.

In some embodiments, the method further includes distinguishing and setting push information of the actual care task according to the care position of the plant and the position information of each co-carer, giving strong prompts to the co-carer within a preset distance, and only giving weak prompts to the co-carer outside the preset distance. The care of the plant is related to the distance between the co-carer and the plant. The co-carer who is far away, for example, in other places, may not care the plant, so they may be given weak reminders (for example, only displaying care task information in a care task list), while the user within a care distance will receive the strong prompts (for example, different interactive reminders such as information pop-up windows, voice, or videos).

In some embodiments, when the actual care task is confirmed to be completed, the care progress information of the plant is synchronized to the co-carer, including: the co-carer who completes the actual care task may upload the specific information of the executed actual care task, and synchronize the latest care task state to other co-carer. The latest care task state is synchronously updated to each co-carer to avoid duplication of care or forgetting to send a care situation. For example, repeated watering in a short period of time or no co-carer watering and caring may cause the plant to become unhealthy or develop symptoms.

Based on the same inventive concept, the disclosure further provides a plant care system. Referring to FIG. 2, FIG. 2 is a schematic view of a structure of a plant care system according to an embodiment of the disclosure. As shown in FIG. 2, the plant care system includes a processor 301, a communication interface 302, a memory 303, and a communication bus 304.

Where, the processor 301, the communication interface 302, and the memory 303 are communicated with each other through the communication bus 304.

The memory 303 is used to store a computer program.

The processor 301 is used to execute the program stored in the memory 303, and implements the following steps:
The plant added by users is received, and the attribute information of the plant is acquired;
The initial care plan for the plant is determined according to the attribute information of the plant, and the initial care plan includes the initial care tasks and the time at which each care task should be executed;
The information of the co-carer of the plant is acquired, and the plant and the actual care task are respectively pushed to the co-carer according to the time at which each initial care task should be executed;
When the actual care task is confirmed to be completed, the care progress information of the plant is synchronized to the co-carer.

For a specific implementation of each step of the method and related explanations, reference may be made to implementations of the method shown in FIG. 1 above, which will not be repeated here.

In addition, other implementations of the plant care method implemented by the processor 301 executing the program stored in the memory 303 are the same as some of the implementations mentioned in the implementations of the aforementioned method, which will also not be repeated here.

The communication bus 304 mentioned in the above electronic device may be a peripheral component interconnect (PCI) bus or an extended industry standard architecture (EISA) bus. The communication bus 304 may be divided into an address bus, a data bus, a control bus, etc. For ease of representation, only one thick line is used in the drawing, but it does not mean that there is only one bus or one type of bus.

The communication interface 302 is used for communication between the above electronic device and other devices.

The processor 301 may be a central processing unit (CPU), and may further be other general-purpose processors, digital signal processors (DSP), application specific integrated circuits (ASIC), field programmable gate arrays (FPGA), or other programmable logic devices, discrete gates, or transistor logic devices, discrete hardware components, etc. The general-purpose processor may be a microprocessor, or the processor may be any conventional processor, etc. The processor 301 is a control center of the electronic device, and is connected to various portions of the entire electronic device using various interfaces and circuits.

The memory 303 may be used to store the computer program. The processor 301 implements various functions of the electronic device by running or executing the computer program stored in the memory 303 and calling data stored in the memory 303.

The memory 303 may include a non-volatile and/or volatile memory. The non-volatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. By way of description and not limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), rambus direct RAM (RDRAM), direct rambus dynamic RAM (DRDRAM), rambus dynamic RAM (RDRAM), etc.

The disclosure further provides a readable storage medium on which the program is stored. When the program is executed, the following steps may be implemented:
The plant added by users is received, and the attribute information of the plant is acquired;
The initial care plan for the plant is determined according to the attribute information of the plant, and the initial care plan includes the initial care tasks and the time at which each care task should be executed;
The information of the co-carer of the plant is acquired, and the plant and the actual care task are respectively pushed to the co-carer according to the time at which each initial care task should be executed;
When the actual care task is confirmed to be completed, the care progress information of the plant is synchronized to the co-carer.

The computer readable storage medium in the embodiment of the disclosure may adopt any combination of one or more computer readable media. The computer readable medium may be a computer readable signal medium or a computer readable storage medium. The computer readable storage medium may be, for example but not limited to, an electronic, magnetic, optical, electromagnetic, infrared, or semiconductor system, apparatus, or device, or any combination of the above. More specific examples (a non-exhaustive list) of the computer readable storage medium includes: an electrical connection having one or more conductive lines, a portable computer hard disk, a hard disk, random access memory (RAM), read-only memory (ROM), erasable programmable read-only memory (EPROM or flash memory), optical fibers, a portable compact disk read-only memory (CD-ROM), an optical memory device, a magnetic memory device, or any suitable combination of the above. Herein, the computer readable storage medium may be any tangible medium that may contains or stores the program, and the program may be used by or in combination with an instruction execution system, apparatus, or device.

The computer readable signal medium may include a data signal propagated in a baseband or as a portion of a carrier wave, which carries a computer readable program code therein. Such a propagated data signal may take a variety of forms, including but not limited to an electromagnetic signal, an optical signal, or any suitable combination of the above. The computer readable signal medium may further be any computer readable medium other than the computer readable storage medium, and the computer readable medium may transmit, propagate or transfer the program for use by or in combination with the instruction execution system, apparatus, or device.

The computer program codes for performing the operations of the disclosure may be written in one or more programming languages, or a combination thereof. The programming language includes object-oriented programming languages such as Java, Smalltalk, C++, and further includes conventional procedural programming languages such as “C” language or similar programming languages. The program code may be completely executed on a computer of the user, partly executed on the computer of the user, executed as a stand-alone software package, executed partly on the computer of the user and partly on a remote computer, or completely executed on the remote computer or server. In cases involving the remote computer, the remote computer may be connected to the computer of the user through any type of network, including a local area network (LAN) or a wide area network (WAN), or may be connected to an external computer (e.g., through the Internet using an Internet service provider).

It should be noted that the devices and methods disclosed in the embodiments herein may also be implemented in other ways. The implementations of the devices described above are merely exemplary. For example, the flowchart and block diagrams in the accompanying drawings show possible system architectures, functions, and, operations of the devices, methods, and computer program products according to various embodiments of the disclosure. In this regard, each box in the flowchart or block diagram may represent a module, a program, or a portion of the code. The module, the program segment, or a portion of the code includes one or more executable instructions for implementing specified logical functions. The module, the program segment, or a portion of the code contains one or more executable instructions for implementing the specified logical functions. It should also be noted that in some alternative embodiments, the functions noted in the boxes may occur in an order different from those noted in the drawings. For example, two consecutive boxes may actually be executed substantially in parallel, or they may sometimes be executed in a reverse order, depending on the functions involved. It should also be noted that each box in the block diagram and/or flowchart and combinations of the boxes in the block diagram and/or flowchart may be implemented by a dedicated hardware-based system for performing the specified functions or operations, or may be implemented by a combination of dedicated hardware and computer instructions.

In addition, the functional modules in the various embodiments herein may be integrated together to form an independent portion, each module may also exist independently, or two or more modules may also be integrated to form an independent portion.

The above description is only a description of the preferred embodiments of the disclosure, and is not intended to limit the scope of the disclosure. Any changes or modifications made by those skilled in the art based on the above disclosure shall fall within the scope of protection of the claims.

1. A plant care method, comprising:
receiving a plant added by a user, and acquiring attribute information of the plant;
determining an initial care plan for the plant according to the attribute information of the plant, wherein the initial care plan comprises a plurality of initial care tasks and time at which each of the initial care tasks should be executed;
acquiring information of a co-carers of the plant, and respectively pushing the plant and an actual care task to the co-carers according to the time at which each of the initial care tasks should be executed;
after it is confirmed that the actual care task has been completed, synchronizing care progress information of the plant to the co-carers.

2. The plant care method according to claim 1, wherein the actual care task is adjusted and then pushed according to the initial care tasks of the care plan and different care ability levels of the co-carers.

3. The plant care method according to claim 2, wherein the different care ability levels of the co-carers are acquired through care history data of the user or in an interactive manner.

4. The plant care method according to claim 1, wherein the co-carers are able to interact with each other to determine the actual care task and a processing method thereof.

5. The plant care method according to claim 1, wherein determining the initial care plan for the plant according to the attribute information of the plant comprises:
determining the initial care plan for the plant according to category information of the plant, a care position of the plant, and the current time.

6. The plant care method according to claim 1, wherein the co-carers comprise an original carer, a newly added carer, and/or a temporary carer.

7. The plant care method according to claim 6, characterized in that, wherein a method of adding the co-carers comprises the following methods:
determining the co-carers by associating a family account;
and/or pushing, through the original carer, a message to the newly added carer and/or the temporary carer to confirm an invitation;
and/or actively adding, by the newly added carer and/or the temporary carer, the same plant with same care position information, and sending collective care information to the original carer to be confirmed by the original carer.

8. The plant care method according to claim 7, wherein the newly added carer and/or the temporary carer comprise a friend whose care ability level meets current plant care requirements or who has relevant plant care experience or other users near the care position, and are selected by the original carer to send an invitation confirmation.

9. The plant care method according to claim 6, wherein the newly added carer and/or the temporary carer are able to invite a third carer to join collective care.

10. The plant care method according to claim 1, wherein, when respectively pushing the plant and the actual care task to the co-carers, the method further comprises pushing historical care record of the plant to the co-carers.

11. The plant care method according to claim 1, wherein the method further comprises distinguishing and setting push information of the actual care task according to a care position of the plant and position information of each of the co-carers, giving strong prompts to the co-carers within a preset distance, and only giving weak prompts to the co-carers outside the preset distance.

12. The plant care method according to claim 1, characterized wherein after it is confirmed that the actual care task has been completed, synchronizing the care progress information of the plant to the co-carers comprises: the co-carers who completes the actual care task is able to upload specific information of the actual care task, which is executed, and synchronize a latest care task state to other co-carers.

13. A plant care system, comprising a processor and a memory, wherein a program is stored in the memory, and when the program is executed by the processor, the plant care method according to claim 1 is implemented.

14. A readable storage medium having a program stored thereon, wherein when the program is executed, the plant care method according to claim 1 is implemented.

15. A plant care system, comprising a processor and a memory, a program is stored in the memory, and when the program is executed by the processor, the plant care method according to claim 2 is implemented.

16. A plant care system, comprising a processor and a memory, a program is stored in the memory, and when the program is executed by the processor, the plant care method according to claim 3 is implemented.

17. A plant care system, comprising a processor and a memory, a program is stored in the memory, and when the program is executed by the processor, the plant care method according to claim 4 is implemented.

18. A plant care system, comprising a processor and a memory, a program is stored in the memory, and when the program is executed by the processor, the plant care method according to claim 5 is implemented.

19. A plant care system, comprising a processor and a memory, a program is stored in the memory, and when the program is executed by the processor, the plant care method according to claim 6 is implemented.

20. A plant care system, comprising a processor and a memory, a program is stored in the memory, and when the program is executed by the processor, the plant care method according to claim 7 is implemented.
